(19) United States
(12) Patent Application Publication
(10) Pub. No.: US 2005/0118079 A1
(43) Pub. Date: Jun. 2, 2005

(54) Method and apparatus for gas treatment using non-equilibrium plasma

(76) Inventors: Kunimasa Muroi, Hamamatsu-shi (JP); Atsushi Ogata, Tsukuba-shi (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/971,646

(22) Filed: Oct. 22, 2004

(30) Foreign Application Priority Data
Oct. 24, 2003 (JP) 2003-364898

(51) Int. Cl. B01J 19/08

(52) U.S. Cl. 422/186.3

(57) ABSTRACT

A gas treatment method is actualized by arranging a plurality of photocatalyst members each including photocatalyst, solid substance, and catalyst in a region of non-equilibrium plasma, which is produced using a surface discharge electrode and into which a treated gas such as an exhaust gas and a harmful gas including harmful chemical substances is introduced and is then subjected to decomposition. The surface discharge electrode comprises a ground electrode, an insulator encompassing the ground electrode, and a plurality of surface electrodes that are arranged relative to the ground electrode via the insulator, by which the non-equilibrium plasma is produced upon electrification. A gas treatment apparatus is constituted by arranging a plurality of surface discharge electrodes, each having a plurality of through holes penetrating in a thickness direction, between which a plurality of photocatalyst members are arranged.

### BACKGROUND OF THE INVENTION

1. Field of the Invention

This invention relates to methods and apparatuses for gas treatment using non-equilibrium plasma produced by use of surface discharge electrodes.

This application claims priority on Japanese Patent Application No. 2003-364898, the content of which is incorporated herein by reference.

2. Description of the Related Art

Exhaust gases emitted from incinerators for general wastes and industrial wastes include harmful chemical substances such as NOx, SOx, and dioxin. In order to avoid environmental pollution and undesirable effects on human bodies, it is required that harmful gases containing harmful chemical substances be rendered harmless by decomposition treatment and then be discharged to the atmosphere.

Conventionally, various gas treatment methods are developed as decomposition treatment methods for harmful gases, among which a specific gas treatment method using electric discharge was developed and put into practical use. This gas treatment method is advantageous in that it does not require aftertreatment due to gas treatment and the apparatus thereof can be reduced in size.

In the gas treatment method using electric discharge, it is possible to use thermal plasma and non-equilibrium plasma (or low-temperature plasma). In particular, the gas treatment method using the non-equilibrium plasma is characterized in that only the electron energy (or electron temperature) is high, but the ion energy and molecular energy (or ion temperature and molecular temperature) is low. Therefore, the gas treatment method using the non-equilibrium plasma is advantageous in that it can be applied to prescribed materials and conditions, which are not suited to high temperature conditions, because gas is subjected to treatment at normal temperature at a high electron temperature, wherein the apparatus producing non-equilibrium plasma can be set up easily. The gas treatment method using the thermal plasma may produce radicals, which are normally difficult to create, so as to actualize specific chemical reactions.

In order to produce non-equilibrium plasma, it is possible to use electric discharge such as corona discharge, silent discharge, spot discharge (or packed-bed type discharge), surface discharge, pulse-streamer discharge (requiring a high voltage pulse generator), and the like.

In particular, when non-equilibrium plasma is produced under atmospheric pressure, it is necessary to use one of the pulse-streamer discharge, silent discharge, and surface discharge. Among them, the surface discharge is frequently used because of a relatively high degree of freedom in designing electrode shapes.

FIG. 12 diagrammatically shows the constitution of a conventionally known surface discharge electrode, which has a cylindrical shape.

The surface discharge electrode of FIG. 12 roughly comprises a ground electrode 1 having a cylindrical shape, a dielectric member 2 having a cylindrical shape encompassing the ground electrode 1, and a plurality of surface electrodes 3, which are arranged in proximity to the interior circumferential surface of the dielectric member 2. The ground electrode 1 and the surface electrode 3 are connected to a power source 5 via wires 4.

In the surface discharge electrode, when the power source 5 applies a voltage between the ground electrode 1 and the surface electrode 3, non-equilibrium plasma is produced on the surface of the surface electrode 3 as shown in FIG. 13, thus forming a plasma layer 6. When gas “g” (hereinafter, referred to as a treated gas) such as exhaust gas and harmful gas including harmful chemical substances such as NOx, SOx, and dioxin is introduced into the plasma layer 6, it is possible to render the treated gas g harmless by the decomposition treatment using the non-equilibrium plasma.

Japanese Patent Application Publication No. 2001-38138 discloses a material treatment apparatus that comprises a honeycomb structure, in which a plurality of through holes are formed in parallel with each other in an insulator allowing gas to pass therethrough, electrodes causing discharge plasma, and a power source for applying a voltage causing the electrodes to produce discharge plasma. This material treatment apparatus can be modified in such a way that through holes are formed in parallel with the electrodes, or through holes are formed perpendicular to the electrodes. In addition, the electrodes are designed to have various shapes such as cylindrical shapes, planar plate shapes, and wire-like shapes.

The conventional gas treatment methods have various problems due to low energy efficiencies, unwanted occurrence of intermediate products, and low efficiency of decomposition treatment.

In particular, the pulse-streamer discharge is relatively expensive and is not practical because it requires a high voltage pulse generator for generating pulses having sharp rises.

In order to improve the decomposition treatment efficiency, it is possible to provide various methods using a photocatalyst such as titanium dioxide and using an adsorbent such as alumina; however, no high-efficiency substance serving as both a photocatalyst and an adsorbent is provided conventionally. The spot discharge (or packed-bed type discharge) using a photocatalyst such as titanium dioxide has problems due to incapability of suppressing the occurrence of nitrogen oxides (NOx). Therefore, the aforementioned problems have not been solved yet.

### SUMMARY OF THE INVENTION

It is an object of the invention to provide a method and an apparatus for gas treatment, which can be performed using non-equilibrium plasma caused by use of discharge electrodes with a relatively low cost.

The gas treatment method of this invention is characterized in that a plurality of photocatalyst members each including photocatalyst, solid substance (excluding photocatalyst), and another catalyst (excluding photocatalyst) are arranged in a non-equilibrium plasma region, into which a treated gas is introduced and is then subjected to decomposition. That is, the treated gas is directly decomposed by the non-equilibrium plasma and is also decomposed by the photocatalyst excited by the non-equilibrium plasma; thus, it is possible to improve the decomposition efficiency for the treated gas. Herein, the photocatalyst member is preferably formed in a solid shape, wherein the photocatalyst is solely used or is supported by another catalyst. The catalyst (excluding the photocatalyst) includes one element or two or more elements selected from among Ag, Au, Ce, Co, Cr, Cu, Fe, Li, Ni, Mn, Mo, Pd, Pt, Rh, V, W, and Zn. In addition, another catalyst includes 5 weight percentage of one element or two or more elements selected from among Ag, Au, Ce, Co, Cr, Cu, Fe, Li, Ni, Mn, Mo, Pd, Pt, Rh, V, W, and Zn, which are supported by a prescribed catalyst support whose specific surface area is 10 m²/g or more.

Preferably, the photocatalyst is composed of titanium oxide, which can be reacted upon ultraviolet radiation or visible radiation. In addition, the solid substance is preferably made by one element or two or more elements selected from among the adsorbent porous substance, dielectric substance, clayey substance, and synthetic resin. Herein, the adsorbent porous substance has a specific surface area that is 200 m²/g or more and is preferably made by one element or two or more elements selected from among HY zeolite, HX zeolite, H mordenite, silica alumina, and metal silicate. Alternatively, the adsorption porous substance has a specific surface area that ranges from 10 m²/g to 750 m²/g and is preferably made by one element or two or more elements selected from among silica alumina, zeolite, silica gel, zirconia, and titania. The non-equilibrium plasma is preferably caused by any one of pulse-streamer discharge, silent discharge, and surface discharge. By use of the aforementioned discharge, it is possible to suppress the amount of nitrogen oxide (NOx) and carbon monoxide (CO), which occur during decomposition of the treated gas.

The surface discharge electrode adapted to the gas treatment apparatus of this invention comprises a ground electrode, an insulator, and surface electrodes, wherein photocatalyst members each including photocatalyst, solid substance, and another catalyst are arranged in the non-equilibrium plasma region.

In the above, a voltage is applied between the ground electrode and the surface electrodes, then, the treated gas is introduced into the non-equilibrium plasma, whereby the treated gas is subjected to decomposition by the non-equilibrium plasma and the photocatalyst excited by the non-equilibrium plasma. As a result, it is possible to improve the decomposition efficiency for the treated gas.

This invention can be easily realized by merely arranging a plurality of photocatalyst members each including photocatalyst, solid substance, and another catalyst; therefore, the gas treatment apparatus of this invention does not require expensive facilities such as high-voltage pulse generators, whereby it is possible to reduce the waste gas decomposition cost with ease.

The surface discharge electrode is designed such that the insulator is firmly attached to the interior circumferential wall of the ground electrode having a cylindrical shape, and the surface electrodes are constituted by spiral coils that are arranged along the interior circumferential wall of the insulator in a coaxial manner with the ‘cylindrical’ ground electrode. Alternatively, the ground electrode is encompassed by the insulator, and a pair of surface electrodes are arranged opposite to each other so as to tightly hold the insulator therebetween.

Since the photocatalyst members are adequately arranged and held in the non-equilibrium plasma region, wherein the treated gas being introduced into the non-equilibrium plasma can be efficiently decomposed due to both the non-equilibrium plasma and the photocatalyst excited by the non-equilibrium plasma; hence, it is possible to improve the decomposition efficiency of the treated gas.

In addition, it is possible to arrange a plurality of surface discharge electrodes, each having a plurality of through holes formed to penetrate therethrough in the thickness direction, with prescribed spaces therebetween, each of which is filled with a plurality of photocatalyst members. Herein, the treated gas passes through the through holes of the surface discharge electrode and is brought into contact with the photocatalyst members, wherein the treated gas is efficiently decomposed due to both of the non-equilibrium plasma and the photocatalyst excited by the non-equilibrium plasma; hence, it is possible to further improve the decomposition efficiency for the treated gas.

### BRIEF DESCRIPTION OF THE DRAWINGS

These and other objects, aspects, and embodiments of the present invention will be described in more detail with reference to the following drawings, in which:

FIG. 1 diagrammatically shows the constitution of a surface discharge electrode for use in a gas treatment apparatus in accordance with a first embodiment of the invention;

FIG. 2 diagrammatically shows the constitution of a surface discharge electrode for use in a gas treatment apparatus in accordance with a second embodiment of the invention;

FIG. 3 diagrammatically shows the modified constitution adapted to the surface discharge electrode used in the second embodiment;

FIG. 4 is a cross sectional view showing essential parts of a gas treatment apparatus in accordance with a third embodiment of the invention;

FIG. 5A is a plan view showing the arrangement of essential parts of a surface discharge electrode adapted to the third embodiment;

FIG. 5B is a front view of the surface discharge electrode shown in FIG. 5A;

FIG. 5C is a cross sectional view taken along line C-C in FIG. 5B;

FIG. 5D is a front view of the surface discharge electrode that is connected with a power source;

FIG. 6 is a cross sectional view showing essential parts of a testing device for use in testing and evaluation of characteristics of photocatalysts used in the first to third embodiments;

FIG. 7 is a graph showing variations of the concentration of benzene (C₆H₆) over time in characteristics evaluation of photocatalyst;

FIG. 8 is a graph showing variations of the concentration of carbon monoxide (CO) over time in characteristics evaluation of photocatalyst;

FIG. 9 is a graph showing variations of the concentration of carbon dioxide (CO₂) over time in characteristics evaluation of photocatalyst;

FIG. 10 is a graph showing variations of the concentration of dinitrogen monoxide (N₂O) over time in characteristics evaluation of photocatalyst;

FIG. 11 is a graph showing variations of the concentration of ozone (O₃) over time in characteristics evaluation of photocatalyst;

FIG. 12 diagrammatically shows a conventionally known surface discharge electrode; and

FIG. 13 is a cross sectional view diagrammatically showing the operation of the surface discharge electrode shown in FIG. 12.

### DESCRIPTION OF THE PREFERRED EMBODIMENTS

This invention will be described in further detail by way of examples with reference to the accompanying drawings.

### 1. First Embodiment

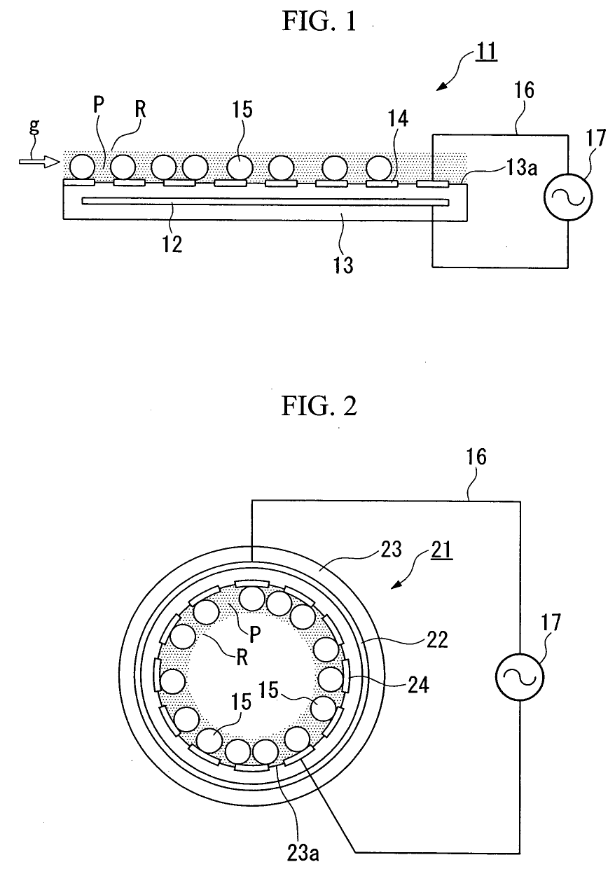

FIG. 1 diagrammatically shows the constitution of a surface discharge electrode for use in a gas treatment apparatus in accordance with a first embodiment of the invention.

A surface discharge electrode 11 shown in FIG. 1 is roughly formed as a planar plate electrode having a disk-like shape, wherein it comprises a ground electrode 12 having a thin disk shape, an insulator 13 having a thick disk shape encompassing the ground electrode 12, a plurality of spiral surface electrodes 14 formed on an upper surface (or a main surface) 13 a of the insulator 13, and a plurality of photocatalyst members 15 each containing photocatalyst and solid substance (excluding photocatalyst), which are arranged in a non-equilibrium plasma region R, wherein the ground electrode 12 and the surface electrode 14 are connected with a power source 17 via wires 16.

The aforementioned surface discharge electrode 11 is not necessarily limited in the outline shape and size thereof, which can be adequately determined as necessary in consideration of the type, amount, and flow velocity of the treated gas.

The ground electrode 12 is formed as a disk-like planar plate electrode, which is arranged substantially at the center of the insulator 13, wherein the thickness thereof ranges from 0.1 mm to 1 mm.

The ground electrode 12 is composed of a conductive and heat-resistive material such as copper, stainless steel, tungsten, silver, and titanium, for example.

The insulator 13 is formed as a planar plate having a rectangular shape, the thickness of which ranges from 1.0 mm to 5.0 mm.

The insulator 13 is composed of an inorganic insulating material such as glass, alumina, silica, barium titanate, and titanium oxide, for example.

The surface electrode 14 serves as a spiral planar plate electrode, which joins the upper surface of the insulator 13 in a closed state and is arranged in parallel with the ground electrode 12, wherein the thickness thereof ranges from 30 μm to 1.0 mm. Similar to the ground electrode 12, the surface electrode 14 is composed of a conductive material such as copper, stainless steel, tungsten, silver, and titanium, for example.

The photocatalyst member 15 contains photocatalyst, solid substance (excluding the photocatalyst), and another catalyst (excluding the photocatalyst). Each of the photocatalyst members 15 is not necessarily limited in shape, wherein it is preferable to use granulated powder in which the photocatalyst, solid substance, and another catalyst are mixed and granulated, and pellets in which the photocatalyst, solid substance, and another catalyst are mixed and pelletized.

Any type of photocatalysts causing the photocatalyst reaction can be used for the photocatalyst member 15. For example, it is possible to use titanium dioxide (TiO₂), zinc oxide (ZnO), cadmium selenide (CdSe), gallium arsenide (GaAs), and strontium titanate (SrTiO₃). In particular, it is preferable to use titanium dioxide (TiO₂), which causes ultraviolet reaction and visible radiation reaction.

It is preferable to use fine grains of titanium dioxide (TiO₂) whose average grain diameter ranges from 5 nm to 300 nm and whose grain sizes range from 3 nm to 500 nm.

When the average grain diameter is less than 5 nm, the bulk factor (or bulk density) becomes small so that the bulk reduction is increased in pressure molding, wherein it is difficult to maintain prescribed shapes formed by grains. When the average grain diameter exceeds 300 nm, surfaces areas of grains decrease to cause a reduction in photo-activity.

In order to improve the decomposition performance, it is preferable that fine grains of titanium dioxide (TiO₂) supports one element or two or more elements selected from among Ag, Au, Ce, Co, Cr, Cu, Fe, Li, Ni, Mn, Mo, Pd, Pt, Rh, V, W, and Zn.

In the above, the photocatalyst can be independently provided, or it can be supported by another catalyst.

It is preferable that the solid substance is composed of a material having a reinforcing function including one element or two or more elements selected from among an adsorption porous substance, a dielectric substance, a clayey substance, and a synthetic resin.

It is preferable that the adsorption porous substance has a specific surface area of 200 m²/g or more and includes one element or two or more elements selected from among HY zeolite, HX zeolite, H mordenite, silica alumina, and metal silicate.

Alternatively, the adsorption porous substance has a specific surface area ranging from 10 m²/g to 750 m²/g and includes one element or two or more elements selected from among silica alumina, zeolite, silica gel, zirconia, and titania.

It is preferable that the dielectric substance is made of barium titanate (BaTiO₃), strontium titanate (SrTiO₃), and the like. It is preferable that the clayey substance is made of magnesium silicate such as talc or smectite such as montmorillonite. As the synthetic resin, it is preferable to use polytetrafluoroethylene (PTFE) and the like.

It is preferable that the catalyst (except the photocatalyst) includes one element or two or more elements selected from among Ag, Au, Ce, Co, Cr, Cu, Fe, Li, Ni, Mn, Mo, Pd, Pt, Rh, V, W, and Zn.

Alternatively, the catalyst is made of a catalyst support whose specific surface area is 10 m²/g or more, wherein it is composed of alumina or cordierite that supports 5 weight percentage or less of one element or two or more elements selected from among Ag, Au, Ce, Co, Cr, Cu, Fe, Li, Ni, Mn, Mo, Pd, Pt, Rh, V, W, and Zn.

Specifically, no regulation is determined with respect to the weight ratio established between the photocatalyst (L), solid substance (S), and catalyst (C) within the photocatalyst member 15. Herein, the weight ratio of the photocatalyst (L) normally ranges from 10 w/w % to 80 w/w /%, more preferably, it ranges from 40 w/w % to 80 w/w %.

This is because the function of the photocatalyst decreases when the weight ratio is less than 10 w/w/ %, and the molded article decreases in strength when the weight ratio exceeds 80 w/w %.

The photocatalyst member 15 is produced as follows:

(a) Granulated Powder of Photocatalyst

First, fine grains of photocatalyst and fine grains of solid substance both having the prescribed average grain diameter are subjected to balancing to realize prescribed composition and are then mixed together using a dry or wet ball mill and the like, thus producing mixed powder.

(b) Pellets of Photocatalyst

A prescribed amount of the mixed powder is filled into a metal mold; then prescribed pressure is applied to the metal mold so as to actualize compressive formation of fine grains.

The compressive formation is performed in the atmosphere, vacuum state, or inert atmosphere, wherein the applied pressure ranges from 500 kg/cm² to 6000 kg/cm², and the pressurizing time ranges from 0.01 second to 60 seconds, for example.

Through the aforementioned process, it is possible to produce pellets (or moldings) including the photocatalyst and solid substance.

These pellets are not necessarily limited in shapes and in arrangement on the surface electrode 14.

Next, a description will be given with respect to the decomposition method regarding the treated gas g such as the exhaust gas and harmful gas including harmful chemical substances such as NOx, SOx, and dioxin by use of the non-equilibrium gas.

First, the ground electrode 12 and the surface electrode 14 are connected with the power source 17 via wires 16, whereby the power source 18 is activated to apply a voltage between the ground electrode 12 and the surface electrode 14, so that non-equilibrium plasma P occurs in the non-equilibrium plasma region R on the surface electrode 14.

Then, the treated gas g such as the exhaust gas and harmful gas including harmful chemical substances such as NOx, SOx, and dioxin is introduced into the non-equilibrium plasma P, whereby the treated gas g is directly decomposed due to the energy of the non-equilibrium plasma P and is adsorbed by the photocatalyst members 15. The treated gas g adsorbed by the photocatalyst member 15 is decomposed by the photocatalyst, which is excited by the energy of the non-equilibrium plasma P as well as the ultraviolet radiation and visible radiation caused by the light emission of the non-equilibrium plasma P, within the photocatalyst member 15. Herein, ozone caused by the non-equilibrium plasma P improves the decomposition efficiency of the photocatalyst.

The treated gas g is subjected to gas treatment using the surface discharge electrode 11 in accordance with the present embodiment, wherein the treated gas g comes in contact with the non-equilibrium plasma P in proximity to the surface of the surface discharge electrode 11 and the surface of the photocatalyst member 15, whereby it is possible to increase the overall contact area between the treated gas g and the non-equilibrium plasma P, thus improving the contact efficiency. That is, both of the non-equilibrium plasma P and the photocatalyst member 15 contribute to the decomposition of the treated gas g, so that chemical reaction progresses very efficiently between the high energy electrons and radicals included in the non-equilibrium plasma P and the harmful chemical substances included in the treated gas g such as NOx, SOx, and dioxin. This actualizes efficient decomposition of harmful chemical substances.

As described above, the surface discharge electrode 11 according to the present embodiment is characterized in that the photocatalyst member 15 including the photocatalyst and solid substance is arranged in the non-equilibrium plasma region R on the surface electrode 14, so that the treated gas g is subjected to decomposition by both of the non-equilibrium plasma P and the photocatalyst included in the photocatalyst member 15 excited by the non-equilibrium plasma P. Thus, it is possible to improve the decomposition efficiency of the treated gas g, and it is therefore possible to increase the amount of decomposition of the treated gas g.

In addition, the surface discharge electrode 11 has a simple constitution and does not require an expensive device such as a high voltage pulse generator; therefore, it is possible to reduce the overall decomposition cost of the treated gas g.

According to the present embodiment in which the treated gas g is subjected to gas treatment by use of the non-equilibrium plasma P, the treated gas g introduced into the non-equilibrium plasma P is subjected to decomposition due to both of the non-equilibrium plasma P and the photocatalyst included in the photocatalyst member 15 excited by the non-equilibrium plasma P; therefore, it is possible to efficiently decompose harmful chemical substances included in the treated gas g such as NOx, SOx, and dioxin.

### 2. Second Embodiment

FIG. 2 diagrammatically shows the constitution of a surface discharge electrode for use in a gas treatment apparatus in accordance with a second embodiment of the invention, wherein parts identical to those of the first embodiment shown in FIG. 1 are designated by the same reference numerals.

A surface discharge electrode 21 comprises an ground electrode 22 having a pipe-like shape (or a cylindrical shape) composed of a conductive material, an insulator 23 having a pipe-like shape (or a cylindrical shape) composed of an insulating material, which encompasses the ground electrode 22 in a closed state, and a plurality of surface electrodes 24 each having a stripe shape that are arranged on an interior circumferential wall 23a of the insulator 23 in a coaxial manner with the ground electrode 22, as well as a photocatalyst member 15 (including photocatalyst and solid substance) arranged in a non-equilibrium plasma region R on the surface electrode 24. All of the surface electrodes 24 are connected with a power source 17 via wires (not shown).

The ground electrode 22, insulator 23, and surface electrode 24 are substantially identical to the ground electrode 12, insulator 13, and surface electrode 14 used in the first embodiment in terms of materials, compositions, operations, and characteristics, whereas they slightly differ from each other in terms of shapes.

Therefore, the surface discharge electrode 21 of the second embodiment can demonstrate similar effects as the surface discharge electrode 11 of the first embodiment.

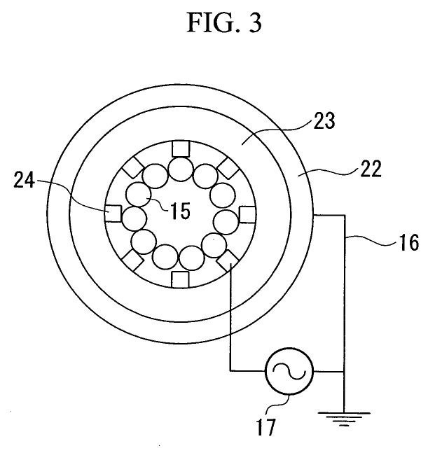

The second embodiment is designed in such a way that the ground electrode 22 is encompassed by the insulator 23 in a closed state, whereas it can be modified such that as shown in FIG. 3, the insulator 23 is arranged inside of the ground electrode 22.

### 3. Third Embodiment

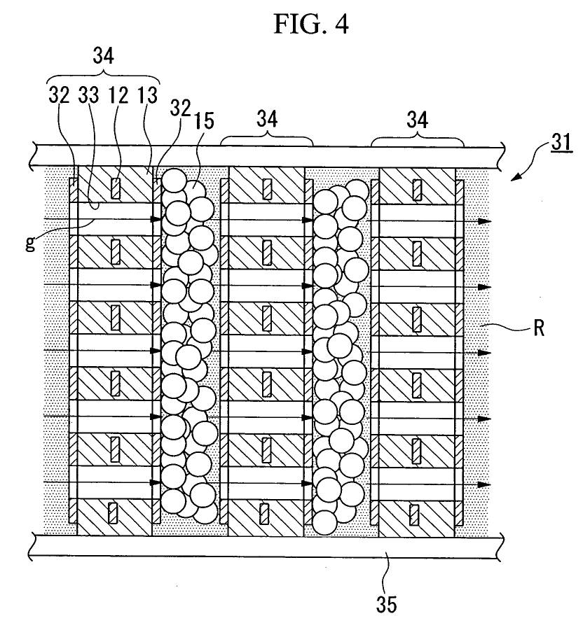

FIG. 4 is a cross sectional view showing essential parts of a gas treatment apparatus in accordance with a third embodiment of the invention, wherein parts identical to those of the first embodiment shown in FIG. 1 are designated by the same reference numerals.

A gas treatment apparatus 31 is installed in an exhaust pipe arranged in an incinerator for treatment of general waste and industrial waste, wherein a plurality of surface discharge electrodes 34 (FIG. 4 shows three sets of surface discharge electrodes 34 arranged in parallel with prescribed distances therebetween) are arranged in a non-equilibrium plasma region R actualized by a treated gas g inside of an exhaust pipe 35 in such a way that they block the exhaust flow in the exhaust pipe 35. The space between the adjacently arranged surface discharge electrodes 34 is filled with photocatalyst members 15 each including photocatalyst and solid substance. The surface discharge electrode 34 comprises a ground electrode 12 serving as a thin plate electrode having a rectangular shape, an insulator 13 serving as a thick plate encompassing the ground electrode 12, and a plurality of surface electrodes 32 that are formed on both sides of the insulator 13, wherein through holes 33 are formed to penetrate through the surface discharge electrode 34 in the thickness direction.

The surface electrode 32 is substantially identical to the surface electrode 14 used in the first embodiment in terms of the material and composition, whereas they slightly differ from each other in shapes.

The number and the shape of the surface discharge electrodes 34 are not necessarily limited as shown in the third embodiment but are adequately determined as necessary in consideration of the flow amount and flow velocity of the treated gas g. As the number of the surface discharge electrodes 34 increases, it is possible to improve the contact efficiency established between the treated gas g and the non-equilibrium plasma. Therefore, it is preferable to increase the number of the surface discharge electrodes 34 when the apparatus treats a relatively large amount of the treated gas g and when the treatment time must be reduced.

In the third embodiment, the surface discharge electrodes 34 are arranged to be perpendicular to the elongated direction of the exhaust pipe 35 in order to block the exhaust flow in the exhaust pipe 35. Of course, the arrangement and the angle formed between the surface discharge electrodes 34 and the exhaust pipe 35 are not necessarily limited to those adopted to the third embodiment. Preferably, the surface discharge electrode 34 serves as a planar plate electrode whose diameter substantially matches the internal diameter of the exhaust pipe 35.

The third embodiment is characterized in that a plurality of surface discharge electrodes 34 are arranged inside of the exhaust pipe 35, whereby harmful chemical substances that are included in the treated gas g and are not completely decomposed by the ‘former’ surface discharge electrode 34 can be completely decomposed by the ‘latter’ surface discharge electrode 34, so that the exhaust gas finally emitted to the atmosphere does not include harmful chemical substances.

In the above, it is preferable that the distance between the adjacent surface discharge electrodes 34 is equal to or less than the width of the non-equilibrium plasma region R. If the distance is within the range of the width of the non-equilibrium plasma region R, it is possible to actualize the efficient decomposition of the treated gas g while the treated gas g passing through the through holes 33 of the ‘former’ surface discharge electrode 34 flows towards the ‘latter’ surface discharge electrode 34.

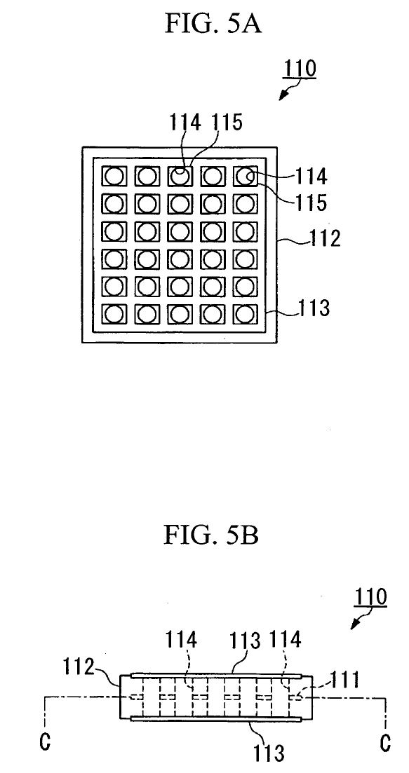

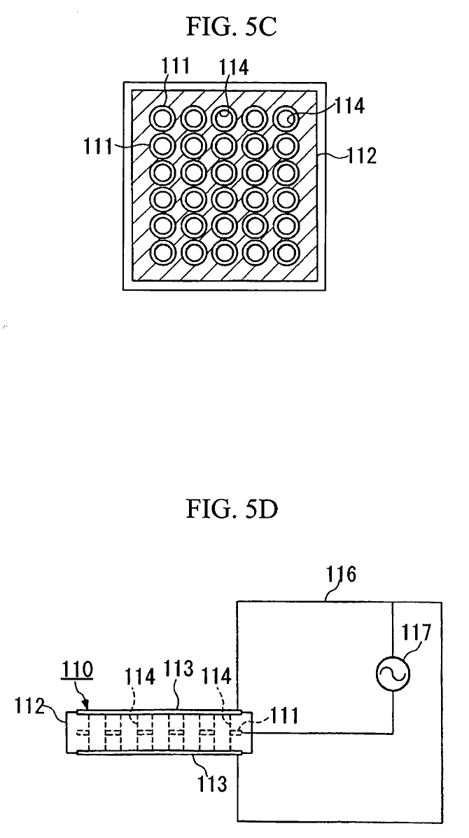

Next, the constitution of a surface discharge electrode will be described in detail with reference to FIGS. 5A to 5D, which show a surface discharge electrode 110 serving as the surface discharge electrode 34 used in the third embodiment, and the content of which is incorporated herein by reference to Japanese Patent Application No. 2002-95555 (that is published in Japan as Japanese Patent Application Publication No. 2003-290623).

FIG. 5A is a plan view showing the arrangement of essential elements of the surface discharge electrode 110; FIG. 5B is a front view of the surface discharge electrode 110; FIG. 5C is a cross sectional view taken along line C-C in FIG. 5B; and FIG. 5D is a front view of the surface discharge electrode 110 that is connected with a power source 117.

The surface discharge electrode 110 serves as a planar plate electrode having a rectangular shape, which comprises a ground electrode 111, an insulator 112 encompassing the ground electrode 111, and a pair of surface electrodes 113 that are arranged in parallel with each other so as to tightly hold the ground electrode 111 and the insulator 112 therein, wherein a plurality of through holes 114 are formed in parallel to penetrate through the surface discharge electrode 110 in a direction perpendicular to the surface electrodes 113. The shape and size of the surface discharge electrode 110 are not necessarily limited as illustrated in FIGS. 5A to 5D and can be adequately determined in consideration of the flow amount and flow velocity of a treated gas. In addition, the through holes 114 are not necessarily formed in parallel with each other and elongated in the perpendicular direction of the surface electrodes 113; hence, they can be formed in a slanted manner being inclined to the perpendicular direction of the surface electrodes 113.

The ground electrode 111 serves as a thin plate electrode having a rectangular shape and is arranged substantially at the center of the cross section of the insulator 112 in parallel with the surface electrodes 113, wherein the thickness thereof ranges from 0.05 mm to 1 mm. The ground electrode 111 is composed of a prescribed material selected from among copper, stainless steel, tungsten, silver, and titanium. The insulator 112 serves as a thick plate having a rectangular shape, wherein the thickness thereof ranges from 1 mm to 5 mm. The insulator 112 is composed of a prescribed material selected from among alumina, glass, barium titanate, and titanium oxide.

Each of the surface electrodes 113 serves as a thin plate electrode having a rectangular shape, wherein they are tightly attached to the opposite surfaces of the insulator 112 and are arranged in parallel with the ground electrode 111, wherein the thickness thereof ranges from 0.05 mm to 1 mm. The surface electrode 113 is composed of a prescribed material selected from among copper, stainless steel, tungsten, silver, and titanium. As shown in FIG. 5A, the surface electrode 113 has a net structure, wherein meshes 115 formed between strand portions of a net respectively match the through holes 114. That is, the openings of the through holes 114 are not covered with the surface electrode 113 but are respectively encompassed by the meshes 115. The size of the mesh 115 is adequately determined in response to the size (or the diameter) of the through hole 114.

The shape of the through hole 114 is not necessarily limited as illustrated in FIG. 5A. It is preferable that the through hole 114 has a circular opening, which may reduce the difference between the contact areas of the plasma and gas in the through hole 114. In addition, it is preferable that the diameter of the opening of the through hole 114 ranges from 0.5 mm to 5 mm. The number of the through holes 114 is not necessarily limited to one as illustrated in FIG. 5A since it is required that the through holes 114 be arranged to substantially cover the entire area of the surface discharge electrode 110. In addition, the arrangement of the through holes 114 is not necessarily limited to one as illustrated in FIGS. 5A to 5C in which the through holes 114 are arranged uniformly or regularly in the surface discharge electrode 110 since it is required that the through holes 114 be arranged to substantially cover the entire area of the surface discharge electrode 110.

In the practical use of the surface discharge electrode 110, the ground electrode 111 and the surface electrodes 113 are connected with the power source 1 17 via conduction lines 116. When the power source 117 applies a voltage between the ground electrode 111 and the surface electrodes 113, it is possible to produce non-equilibrium plasma. Actually, the non-equilibrium plasma occurs in proximity to the surfaces of the surface electrodes 113 and in the through holes 114 along their elongated directions. In other words, the non-equilibrium plasma occurs in three-dimensional directions with respect to the surface discharge electrode 110, whereby it is possible to increase the overall area contributing to the occurrence of the non-equilibrium plasma. Herein, the non-equilibrium plasma occurs uniformly in the through hole 114 in both of the diameter direction and elongated direction. Therefore, when the aforementioned surface discharge electrode 110 is used for the gas treatment regarding the exhaust gas and harmful gas (i.e., the treated gas), it is possible to establish good contacts between the treated gas and the non-equilibrium plasma on the surfaces of the surface discharge electrode 110 as well as in the through holes 114. This increases the overall contact area between the treated gas and the non-equilibrium plasma, whereby it is possible to improve the contact efficiency established between the treated gas and non-equilibrium plasma. For this reason, desired chemical reaction progresses efficiently between high-energy electrons and radicals, which are included in the non-equilibrium plasma, and harmful chemical substances such as NOx, SOx, and dioxin included in the treated gas; thus, it is possible to efficiently decompose harmful chemical substances.

Now, referring back to the third embodiment shown in FIG. 4, the photocatalyst member 15 is not necessarily limited in the foregoing shape. Preferably, the shape and size of the photocatalyst member 15 are determined to allow random arrangement inside of the exhaust pipe 35 in order to cause turbulent gas flow inside of the exhaust pipe 35. For example, the photocatalyst member 15 has a pellet tablet shape, a cylindrical shape, a spherical shape, and the like.

### 4. Characteristics Evaluation Results

Next, characteristics evaluation results regarding photocatalysts used in the first to third embodiments will be described.

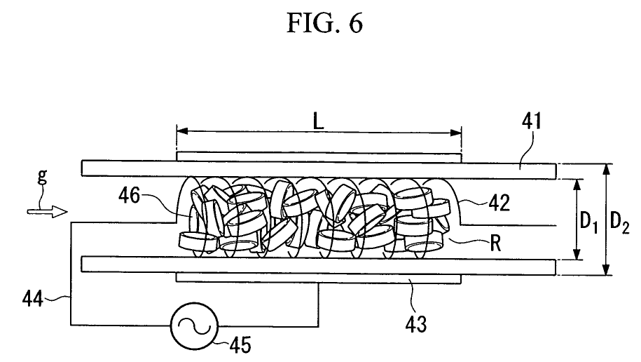

FIG. 6 is a cross sectional view showing essential parts of a testing device for use in testing and evaluation of characteristics of photocatalysts, wherein reference numeral 41 designates an exhaust pipe made of quartz glass; reference numeral 42 designates an internal electrode made of a stainless steel having a coil shape that is arranged inside of the exhaust pipe 41; and reference numeral 43 designates an external electrode made of a copper plate having a cylindrical shape that is arranged in the outer periphery of the exhaust pipe 41 in a coaxial manner with the internal electrode 42, wherein the internal electrode 42 and the external electrode 43 are connected with a power source 45 via wires 44.

In the testing device of FIG. 6, the region occupied by the internal electrode 42 is used as the non-equilibrium plasma region R, in which a plurality of pellets of photocatalyst members 46 are arranged randomly.

The testing device is assembled by connecting the internal electrode 42 and the external electrode 43 to the power source 45 via the wires 44, wherein when the power source 45 is activated to apply a voltage between the internal electrode 42 and the external electrode 43, non-equilibrium plasma occurs in the non-equilibrium plasma region R in proximity to the internal circumferential wall of the internal electrode 42. In this state, when a treated gas g is introduced into the non-equilibrium plasma region R, it is subjected to decomposition by the photocatalyst included in the photocatalyst member 46 that is excited due to the energy of the non-equilibrium plasma and the ultraviolet radiation and visible radiation caused by the light emission of the non-equilibrium plasma, whereby it is possible to exhaust the gas, from which harmful chemical substances are removed, from the output terminal of the exhaust pipe 41.

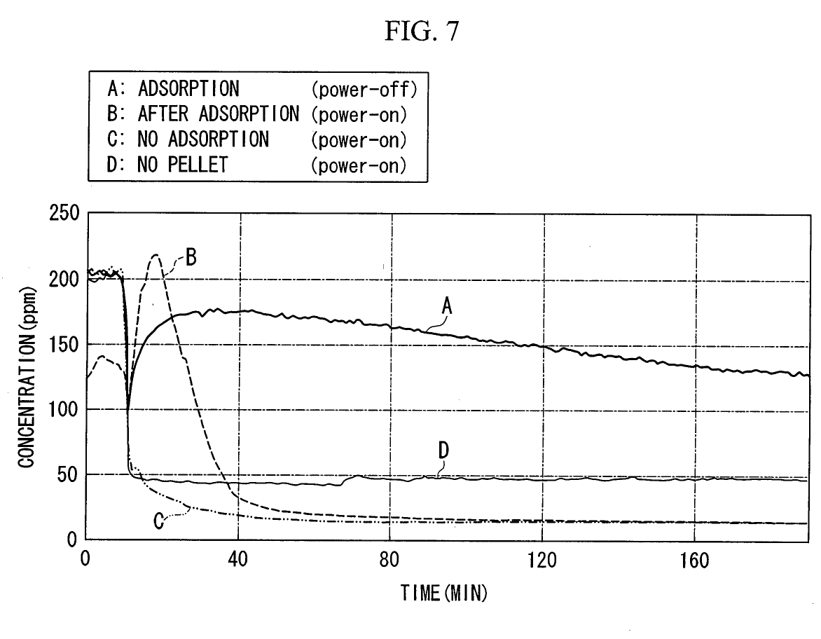

Next, characteristics evaluation results of photocatalysts produced by the aforementioned testing device will be described in detail with reference to graphs shown in FIGS. 7 to 11.

Herein, the surface discharge is used as the electric discharge method, and the power source produces ac voltage at 24 kHz with the primary side power of 3 W. A tested gas includes benzene (C₆H₆) at 200 ppm added to air (including 20 v/v % of O₂ and 80 v/v % of N₂), wherein the flow velocity therefor is set to 200 mL/min. The photocatalyst member 46 is actualized by pellets including 66 weight percentage of titanium dioxide and 34 weight percentage of polytetrafluoroethylene (PTFE).

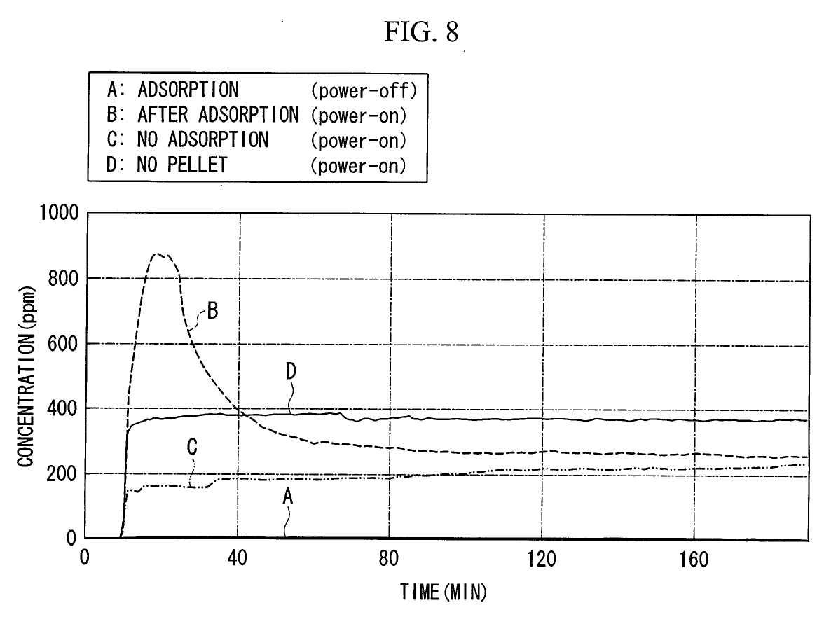

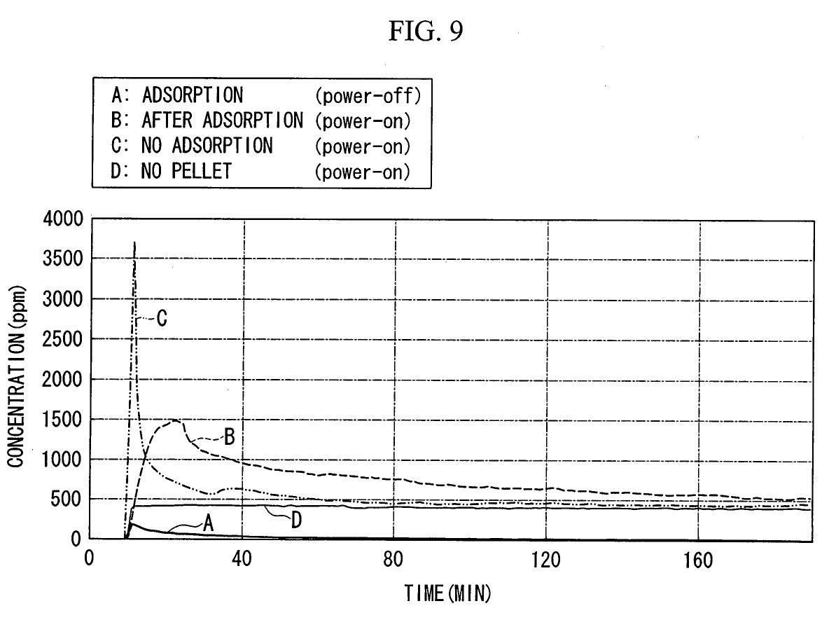

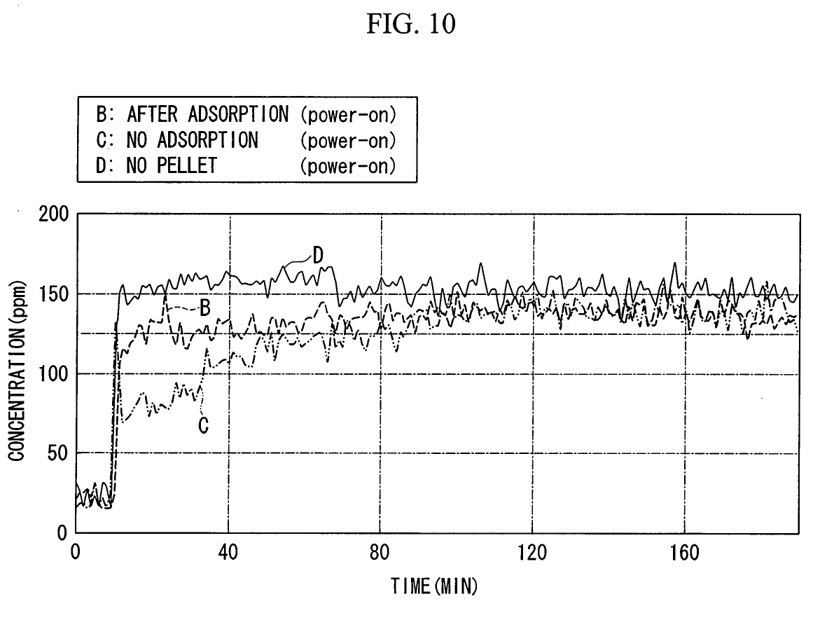

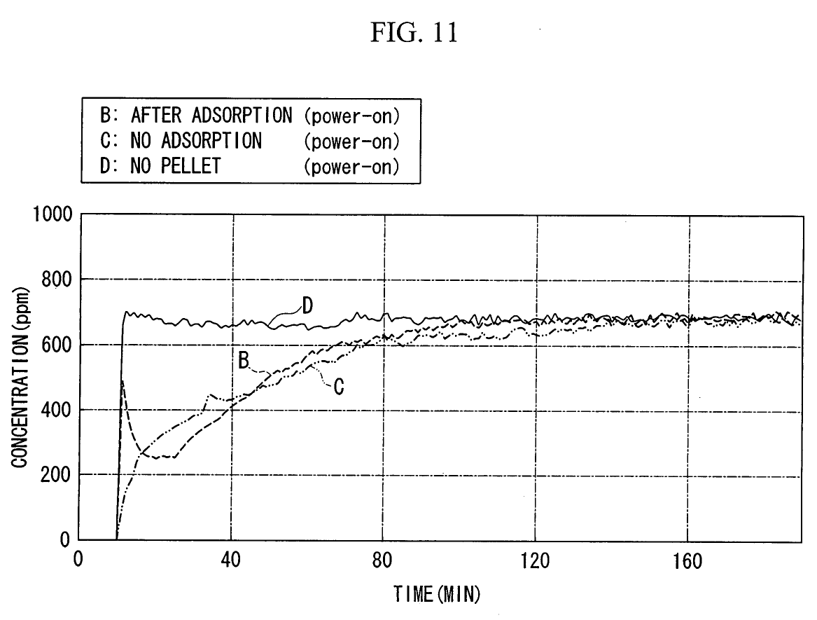

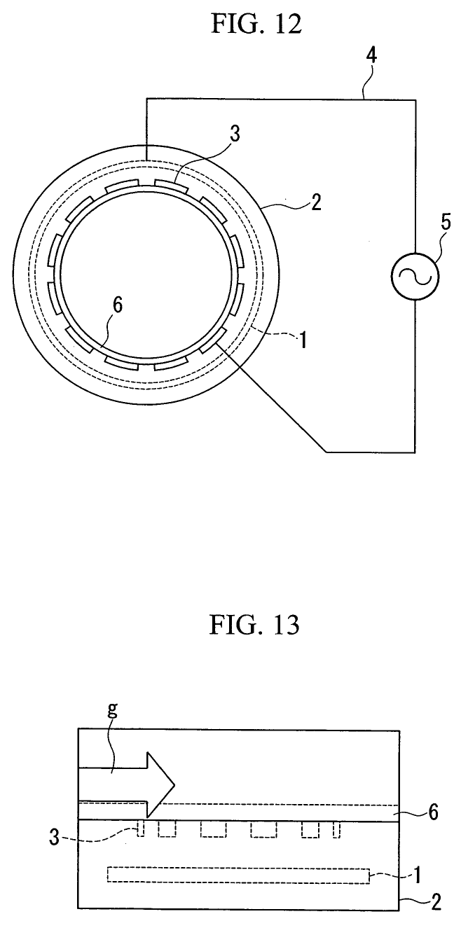

FIGS. 7 to 11 are graphs showing characteristics evaluation results of photocatalysts produced by the testing device of FIG. 6, wherein FIG. 7 shows concentration (ppm) of benzene (C₆H₆); FIG. 8 shows concentration (ppm) of carbon monoxide (CO); FIG. 9 shows concentration (ppm) of carbon dioxide (CO₂); FIG. 10 shows concentration (ppm) of dinitrogen monoxide (N₂O); and FIG. 11 shows concentration (ppm) of ozone (O₃). In these graphs, reference symbol “A” designates an adsorption characteristic curve regarding pellet adsorption; reference symbol “B” designates a characteristic curve that is produced when plasma is introduced after pellet adsorption; reference symbol “C” designates a characteristic curve that is produced when a tested gas is introduced into plasma without pellet adsorption; and reference symbol “D” designates a characteristic curve that is produced when a tested gas is introduced into plasma without using pellets.

The aforementioned characteristics evaluation results clearly show the following conclusions.

(1) The concentration of benzene (C₆H₆) decreases over time due to the adsorption only.

That is, when plasma is introduced into the testing device after adsorption, a peak due to desorption of benzene appears in the initial stage, and finally, the concentration of benzene decreases from 200 ppm to 15 ppm.

The elimination rate of benzene reaches 92% when plasma is introduced into the testing device without pellet adsorption.

The elimination rate of benzene is 76% in the case where testing is performed using plasma only.

The elimination rate of benzene is improved by 17% by use of pellets.

(2) With regard to the concentration of carbon monoxide (CO) after 180 minutes in testing, the characteristic curve B shows 260 ppm, the characteristic curve C shows 230 ppm, and the characteristic curve D shows 370 ppm.

(3) With regard to the concentration of carbon dioxide (CO₂) after 180 minutes in testing, the characteristic curve B shows 530 ppm, the characteristic curver C shows 450 ppm, and the characteristic curve D shows 405 ppm.

With regard to the carbon mass balance in the aforementioned cases (2) and (3), the characteristic curve B shows 71%, the characteristic curve C shows 60%, and the characteristic curve D shows 85%. Herein, the selectivity of carbon dioxide (CO₂) can be improved as well.

(4) With regard to the concentration of dinitrogen monoxide (N₂O), each of the characteristic curves B to D finally shows 140 ppm wherein small differences can be observed therebetween in the initial stage of reaction. Incidentally, no nitrogen oxide (NOx) is detected in testing.

(5) With regard to the concentration of ozone (O₃), each of the characteristic curves B to D finally shows 680 ppm wherein small differences can be observed therebetween in the initial stage of reaction.

As described heretofore, this invention is characterized in that the treated gas is subjected to decomposition by use of both of the non-equilibrium plasma and the photocatalyst excited by the non-equilibrium plasma, whereby it is possible to efficiently decompose and eliminate various harmful chemical substances such as NOx, SOx, and dioxin. Therefore, this invention demonstrates noticeable effects in various industrial fields because this invention actualizes effective decomposition of exhaust gases emitted from incinerators for general waste and industrial waste, exhaust gases emitted from automobiles, and other harmful gases including harmful chemical substances, which can be rendered harmless.

As this invention may be embodied in several forms without departing from the spirit or essential characteristics thereof, the present embodiments are therefore illustrative and not restrictive, since the scope of the invention is defined by the appended claims rather than by the description preceding them, and all changes that fall within metes and bounds of the claims, or equivalents of such metes and bounds are therefore intended to be embraced by the claims.

1. A gas treatment method in which a treated gas is introduced into non-equilibrium plasma including a plurality of photocatalyst members each including photocatalyst, solid substance, and catalyst, by which the treated gas is subjected to decomposition.

2. The gas treatment method according to claim 1, wherein each of the photocatalyst members is formed in a prescribed shape.

3. The gas treatment method according to claim 1, wherein the photocatalyst is independently included in the photocatalyst member, or the photocatalyst is supported by the catalyst.

4. The gas treatment method according to claim 1, wherein the catalyst includes one element or two or more elements selected from among Ag, Au, Ce, Co, Cr, Cu, Fe, Li, Ni, Mn, Mo, Pd, Pt, Rh, V, W, and Zn.

5. The gas treatment method according to claim 1, wherein the catalyst includes 5 weight percentage or less of one element or two or more elements selected from among Ag, Au, Ce, Co, Cr, Cu, Fe, Li, Ni, Mn, Mo, Pd, Pt, Rh, V, W, and Zn, which are supported by a prescribed catalyst support whose specific surface area is 10 m²/g or more.

6. The gas treatment method according to claim 1, wherein the photocatalyst is composed of titanium oxide that reacts under ultraviolet radiation or visible radiation.

7. The gas treatment method according to claim 1, wherein the solid member is made by one element or two or more element selected from among adsorbent porous substance, dielectric substance, clayey substance, and synthetic resin.

8. The gas treatment method according to claim 1, wherein the adsorbent porous substance has a specific surface area of 200 m²/g or more and is made by one element or two or more elements selected from among HY zeolite, HX zeolite, H mordenite, silica alumina, and metal silicate.

9. The gas treatment method according to claim 1, wherein the adsorption porous substance has a specific surface ranging from 10 m²/g to 750 m²/g and is made by one element or two or more elements selected from among silica alumina, zeolite, silica gel, zirconia, and titania.

10. The gas treatment method according to claim 1, wherein the non-equilibrium plasma is caused by any one of pulse-streamer discharge, silent discharge, and surface discharge.

11. A surface discharge electrode for use in gas treatment, comprising:
a ground electrode;
an insulator;
a plurality of surface electrodes that are arranged relative to the ground electrode via the insulator; and
a plurality of photocatalyst members each including photocatalyst, solid substance, and catalyst, which are arranged in a non-equilibrium plasma region.

12. The surface discharge electrode according to claim 11, wherein the ground electrode has a cylindrical shape whose internal circumferential wall is covered with the insulator, and wherein the surface electrodes are constituted by spiral coils that are arranged on an internal circumferential wall of the insulator in a coaxial manner with the ground electrode.

13. The surface discharge electrode according to claim 11, wherein the ground electrode is encompassed by the insulator, so that a pair of the surface electrodes are arranged opposite to each other to tightly hold the insulator therebetween.

14. The surface discharge electrode according to claim 13, wherein a plurality of through holes are formed to penetrate through in a thickness direction, allowing a treated gas to pass therethrough.

15. A gas treatment apparatus comprising at least one surface discharge electrode, which comprises a ground electrode, an insulator, a plurality of surface electrodes that are arranged relative to the ground electrode via the insulator, and a plurality of photocatalyst members each including photocatalyst, solid substance, and catalyst, which are arranged in a non-equilibrium plasma region.

16. A gas treatment apparatus comprising:
a plurality of surface discharge electrodes, each of which comprises a ground electrode, an insulator encompassing the ground electrode, and a pair of surface electrodes arranged opposite to each other so as to tightly hold the insulator therebetween, wherein the plurality of surface discharge electrodes are arranged in parallel with each other with a prescribed space therebetween;
a plurality of through holes formed to penetrate through each of the surface discharge electrodes in a thickness direction; and
a plurality of photocatalyst members each including photocatalyst, solid substance, and catalyst, which are arranged in the space formed between the surface discharge electrodes arranged adjacent to each other.

17. The gas treatment method according to claim 2, wherein the catalyst includes one element or two or more elements selected from among Ag, Au, Ce, Co, Cr, Cu, Fe, Li, Ni, Mn, Mo, Pd, Pt, Rh, V, W, and Zn.

18. The gas treatment method according to claim 3, wherein the catalyst includes one element or two or more elements selected from among Ag, Au, Ce, Co, Cr, Cu, Fe, Li, Ni, Mn, Mo, Pd, Pt, Rh, V, W, and Zn.

19. The gas treatment method according to claim 2, wherein the catalyst includes 5 weight percentage or less of one element or two or more elements selected from among Ag, Au, Ce, Co, Cr, Cu, Fe, Li, Ni, Mn, Mo, Pd, Pt, Rh, V, W, and Zn, which are supported by a prescribed catalyst support whose specific surface area is 10 m²/g or more.

20. The gas treatment method according to claim 3, wherein the catalyst includes 5 weight percentage or less of one element or two or more elements selected from among Ag, Au, Ce, Co, Cr, Cu, Fe, Li, Ni, Mn, Mo, Pd, Pt, Rh, V, W, and Zn, which are supported by a prescribed catalyst support whose specific surface area is 10 m²/g or more.

21. The gas treatment method according to claim 2, wherein the photocatalyst is composed of titanium oxide that reacts under ultraviolet radiation or visible radiation.

22. The gas treatment method according to claim 3, wherein the photocatalyst is composed of titanium oxide that reacts under ultraviolet radiation or visible radiation.

23. The gas treatment method according to claim 2, wherein the solid member is made by one element or two or more element selected from among adsorbent porous substance, dielectric substance, clayey substance, and synthetic resin.

24. The gas treatment method according to claim 3, wherein the solid member is made by one element or two or more element selected from among adsorbent porous substance, dielectric substance, clayey substance, and synthetic resin.

25. The gas treatment method according to claim 2, wherein the adsorbent porous substance has a specific surface area of 200 m²/g or more and is made by one element or two or more elements selected from among HY zeolite, HX zeolite, H mordenite, silica alumina, and metal silicate.

26. The gas treatment method according to claim 3, wherein the adsorbent porous substance has a specific surface area of 200 m²/g or more and is made by one element or two or more elements selected from among HY zeolite, HX zeolite, H mordenite, silica alumina, and metal silicate.

27. The gas treatment method according to claim 2, wherein the adsorption porous substance has a specific surface ranging from 10 m²/g to 750 m²/g and is made by one element or two or more elements selected from among silica alumina, zeolite, silica gel, zirconia, and titania.

28. The gas treatment method according to claim 3, wherein the adsorption porous substance has a specific surface ranging from 10 m²/g to 750 m²/g and is made by one element or two or more elements selected from among silica alumina, zeolite, silica gel, zirconia, and titania.

29. The gas treatment method according to claim 2, wherein the non-equilibrium plasma is caused by any one of pulse-streamer discharge, silent discharge, and surface discharge.

30. The gas treatment method according to claim 3, wherein the non-equilibrium plasma is caused by any one of pulse-streamer discharge, silent discharge, and surface discharge.
